(19) United States
(12) Patent Application Publication
(10) Pub. No.: US 2026/0279031 A1
(43) Pub. Date: Sep. 17, 2026

(54) FUSION IMAGE GENERATING METHOD AND APPARATUS, AND STORAGE MEDIUM STORING INSTRUCTIONS FOR PERFORMING FUSION IMAGE GENERATING METHOD

(71) Applicant: AGENCY FOR DEFENSE DEVELOPMENT, Daejeon (KR)

(72) Inventors: Seongyong AHN, Daejeon (KR); Jihong MIN, Daejeon (KR); Sungdae SIM, Daejeon (KR)

(21) Appl. No.: 19/479,810

(22) PCT Filed: Mar. 13, 2024
(86) PCT No.: PCT/KR2024/003202

§ 371 Date: Oct. 29, 2025

(30) Foreign Application Priority Data
Jun. 30, 2023 (KR) 10-2023-0084785

(51) Int. Cl. G06V 10/80; G06T 11/10; G06T 11/60; G06V 10/82

(52) U.S. Cl. CPC G06V 10/806; G06T 11/10; G06T 11/60; G06V 10/82

(57) ABSTRACT

A fusion image generating method using a fusion image generating apparatus, according to an embodiment, comprises the steps of: performing temporal and spatial synchronization of color images and thermal images and preprocessing into preset formats; generating multidimensional color image spectrum features from the preprocessed color images by using a color image encoder in a pre-trained neural network; generating a multidimensional thermal image spectrum feature from the preprocessed thermal images by using a thermal image encoder in the pre-trained neural network; and generating fusion images by fusing the multidimensional color image spectrum features and the multidimensional thermal image spectrum features by using a fusion image decoder in the pre-trained neural network.

### TECHNICAL FIELD

The present invention relates to a method for generating a fusion image and a device for performing this method.

### BACKGROUND

Ground unmanned equipment such as autonomous vehicles, as well as various other robotic systems, fundamentally require the perception and recognition of their surrounding environment. In order to perceive and recognize the surrounding environment, the first prerequisite is to sense the target environment. For this reason, these devices and systems are equipped with and utilize various types of sensors, such as camera sensors, ultrasonic sensors, and laser distance-measuring sensors.

Among the various sensors, camera sensors, which provide information most similar to that perceived by the human eye and offer a high density of information, are being utilized in the majority of equipment and systems. These camera sensors primarily use color image cameras, while some surveillance and military equipment use thermal imaging cameras.

However, while a color video camera provides detailed information, it is greatly affected by factors such as the amount and direction of light, and a thermal imaging camera is less affected by the sensing environment but has the problem of not providing detailed information. Accordingly, there has been a growing demand for the generation of fused images that utilize both sensors to provide a single, integrated image that minimizes the influence of sensing conditions and environments while including rich information.

The method for generating such fused images, before the advent of deep learning technology, involved directly designing and applying fixed-form filters to extract the information to be reflected in the fused images. However, fixed-form filters were not only difficult to apply to various situations, but their performance in information extraction was also inferior to that of deep learning technology.

When applying deep learning technology to generate fusion images, it has become possible to create fusion images that reflect richer information by extracting and combining features necessary for fusion at a higher level through neural networks.

However, there was an issue in that a large amount of spatially and temporally aligned color images and thermal images are required to train a neural network. This issue arises because images from different bands are acquired through physically separate sensors, making it not only very time-consuming to align the two images, but also extremely difficult to achieve perfect alignment despite the effort. Therefore, in order to easily apply deep learning-based fusion image generation techniques utilizing neural networks to actual systems, it is necessary to minimize the effort required to prepare training data for neural network training.

### DETAILED DESCRIPTION OF THE INVENTION

### Technical Problem

According to one embodiment, a method and a device for generating a fused image are provided, which generate a fused image using a pre-trained neural network after performing alignment and preprocessing in a predetermined format for a color image and a thermal image.

However, the problems to be solved by the present invention are not limited to those mentioned above, and other problems to be solved that are not mentioned can be clearly understood by those of ordinary skill in the art to which the present invention pertains from the following description.

### Technical Solution

A method for generating a fused image using a fused image generation device according to first aspect includes: performing temporal and spatial synchronization on a color image and a thermal image, and preprocessing them into a predetermined format; generating multi-dimensional color image spectrum features from the preprocessed color image using a color image encoder within a pre-trained neural network; generating multi-dimensional thermal image spectrum features from the preprocessed thermal image using a thermal image encoder within the pre-trained neural network; and generating a fused image by fusing the multi-dimensional color image spectrum features and the multi-dimensional thermal image spectrum features using a fused image decoder within the pre-trained neural network.

A fusion image generation device according to second aspect includes a memory including instructions, and a processor that executes the instructions. By executing the instructions, the processor performs alignment and predetermined format preprocessing on the color image and the thermal image, generates multi-dimensional color image spectrum features from the preprocessed color image using a color image encoder within a pre-trained neural network, generates multi-dimensional thermal image spectrum features from the preprocessed thermal image using a thermal image encoder within the neural network, and fuses the multi-dimensional color image spectrum features and the multi-dimensional thermal image spectrum features using a fusion image decoder within the neural network to generate a fusion image.

According to the third aspect, as a non-transitory computer-readable recording medium on which a computer program is stored, the computer program, when executed by a processor, includes instructions to cause the processor to perform the following steps: performing temporal and spatial synchronization on a color image and a thermal image, and pre-processing them in a preset format; generating multi-dimensional color image spectrum features from the pre-processed color image using an encoder for color images within a pre-trained neural network; generating multi-dimensional thermal image spectrum features from the pre-processed thermal image using an encoder for thermal images within the pre-trained neural network; and fusing the multi-dimensional color image spectrum features and the multi-dimensional thermal image spectrum features using a decoder for fusion images within the pre-trained neural network to generate a fusion image.

According to the fourth aspect, as a computer program stored on a computer-readable recording medium, when the computer program is executed by a processor, the processor performs the steps of: temporally and spatially synchronizing the color image and the thermal image, and preprocessing them in a predetermined format; generating multi-dimensional color image spectral features from the preprocessed color image using the encoder for color images within the pre-trained neural network; generating multi-dimensional thermal image spectral features from the preprocessed thermal image using the encoder for thermal images within the pre-trained neural network; and fusing the multi-dimensional color image spectral features and the multi-dimensional thermal image spectral features using the decoder for fusion images within the pre-trained neural network to generate a fusion image. The computer-readable recording medium includes instructions for causing the processor to perform these steps of the fusion image generation method.

### Effect of Invention

According to one embodiment, a method and a device for generating a fusion image are provided, which generate a fusion image using a pre-trained neural network after aligning and preprocessing color images and thermal images in a preset format. For example, to be utilized in ground unmanned equipment such as autonomous vehicles, as well as in various other robotic systems, image fusion can be generated in order to minimize environmental influences in image information greatly affected by external environmental factors such as the direction and intensity of light. When multiple systems utilizing image information are operated with both color image cameras and thermal image cameras installed simultaneously, and the generated fusion images are used for sensing the target environment, not only can the performance of the system be improved in remote control (driving), assisted control (driving), and fully autonomous (automatic) control (driving), but stability can also be enhanced.

In addition, the present invention does not require the temporal and spatial alignment of input images (color images, thermal images), which was essential for training the neural network that generates fusion images, and allows training to be performed with only a set of color images and a set of thermal images, regardless of whether they are aligned. As a result, there is the advantage of overcoming the difficulty of having to separately obtain or prepare aligned images for training.

### BRIEF DESCRIPTION OF THE DRAWINGS

FIG. 1 is an exemplary diagram of a fused image utilization system to which a fused image generation device according to an embodiment of the present invention can be applied.

FIG. 2 is a block diagram of a fused image generation device according to an embodiment of the present invention.

FIG. 3 is a conceptual block diagram illustrating the functions of a fused image generation program constituting the fused image generation device according to an embodiment of the present invention.

FIG. 4 is an exemplary detailed block diagram of a neural network included in the fused image generation program constituting the fused image generation device according to an embodiment of the present invention.

FIG. 5 is a flowchart for explaining a method for generating fused image performed by the fused image generation device according to an embodiment of the present invention.

### BEST FORM FOR PRACTICING THE INVENTION

The advantages and features of the present invention, as well as methods for achieving them, will become apparent with reference to the embodiments described in detail below in conjunction with the accompanying drawings. However, the present invention is not limited to the embodiments disclosed herein but may be embodied in various different forms. These embodiments are merely provided to ensure the completeness of the disclosure of the present invention and to fully convey the scope of the invention to those skilled in the art to which the invention pertains. The present invention is defined only by the scope of the claims.

In describing the embodiments of the present invention, detailed descriptions of known functions or configurations will be omitted when it is determined that such detailed descriptions may unnecessarily obscure the gist of the present invention. Furthermore, the terms described below are terms defined in consideration of the functions in the embodiments of the present invention, and these may vary depending on the intentions or practices of users or operators. Therefore, their definitions should be based on the overall contents of this specification.

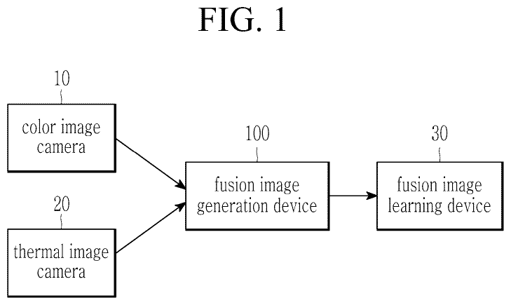

FIG. 1 is an example diagram of a fusion image utilization system to which the fusion image generation device according to an embodiment of the present invention can be applied.

A color image captured by the color image camera 10 and a thermal image captured by the thermal image camera 20 are input into the fusion image generation device 100 regardless of temporal or spatial alignment, and the fusion image generation device 100, after aligning and preprocessing the input color and thermal images into a preset format, generates a fusion image using a pre-trained neural network and provides it to the fusion image learning device 30. The fusion image learning device 30 may be a system that requires sensing of the target environment, such as ground unmanned equipment including autonomous vehicles, or various other robotic systems, and the fusion image provided by the fusion image generation device 100 can be utilized as training data for environment sensing.

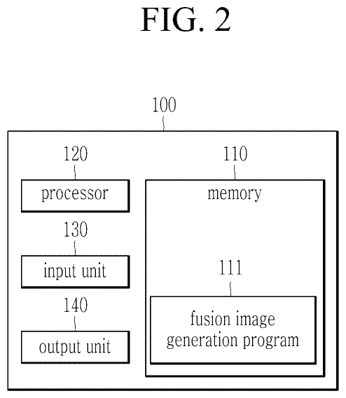

FIG. 2 is a block diagram of a fusion image generating device 100 according to an embodiment of the present invention.

The fusion image generation device 100 according to one embodiment includes a memory 110 in which a fusion image generation program 111 is stored and a processor 120, and may further include an input unit 130 and/or an output unit 140. For example, the fusion image generation device 100 can be implemented by a computing device that includes computing means such as a microprocessor and input/output interfacing means.

The memory 110 of the fusion image generation device 100 may further store various types of information necessary for execution of the fusion image generation program 111, and the fusion image generation program 111 may include instructions that can be executed by the processor 120. For example, the fusion image generation program 111 may refer to software that includes programmed instructions to perform preprocessing on the color image and thermal image by aligning and formatting them in a predetermined format, and then generate a fusion image using a pre-trained neural network.

The processor 120 of the fusion image generation device 100 can load and execute the fusion image generation program 111 from the memory 110. By executing the instructions of the fusion image generation program 111, the processor 120 can perform the fusion image generation method according to an embodiment of the present invention.

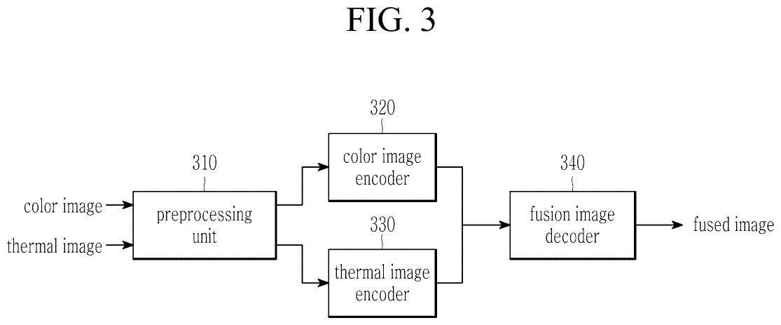

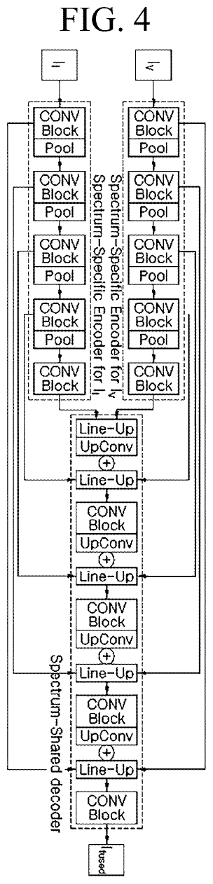

FIG. 3 is a block diagram conceptually illustrating the functions of the fusion image generation program 111 according to one embodiment of the present invention, and FIG. 4 is an exemplary detailed configuration diagram of the neural network included in the fusion image generation program 111 constituting the fusion image generation device 100 according to one embodiment of the present invention.

Referring to FIGS. 3 and 4, the fusion image generation program 111 may include a preprocessing unit 310, a color image encoder 320, a thermal image encoder 330, and a fusion image decoder 340. These preprocessing unit 310, color image encoder 320, thermal image encoder 330, and fusion image decoder 340 are only conceptual divisions of the functions of the fusion image generation program 111 and are not limited thereto. According to embodiments, the respective functions of the preprocessing unit 310, color image encoder 320, thermal image encoder 330, and fusion image decoder 340 may be merged or separated, and can be implemented as a series of instructions included in a single program.

The pre-processing unit 310 of the fusion image generation program 111 performs alignment and pre-processing of the color image and thermal image into predetermined formats. For example, the pre-processing unit 310 may convert the color image into YCbCr format and then provide the Y channel as input to the color image encoder 320. In addition, the pre-processing unit 310 may provide the thermal image as an 8-bit single channel to be used as input for the thermal image encoder 330.

The color image encoder 320 of the fusion image generation program 111 can be pre-trained to generate multi-dimensional color image spectrum features from the preprocessed color image. For example, as illustrated in FIG. 4, the color image encoder 320 may be implemented with five convolution blocks each composed of two 3×3 convolution filters and two activation layers, as well as four 2×2 max pooling layers. This color image encoder 320 may be referred to as a spectrum-specific encoder.

The thermal image encoder 330 of the fusion image generation program 111 can be pre-trained to generate multi-dimensional thermal image spectrum features from pre-processed thermal images. For example, similar to the color image encoder 320, the thermal image encoder 330 can be implemented with five convolution blocks, each consisting of two 3×3 convolution filters and two activation layers, and four 2×2 max pooling layers. Like the color image encoder 320, the thermal image encoder 330 can be referred to as a spectrum feature encoder.

The fusion image decoder 340 of the fusion image generation program 111 can be pre-trained to generate a fusion image by combining multi-dimensional color image spectrum features and multi-dimensional thermal image spectrum features. For example, as illustrated in FIG. 4, the fusion image decoder 340 can be implemented with four convolutional blocks, each consisting of two 3×3 convolution filters and two activation layers, and five 2×2 up-convolution layers. For instance, in order to prevent loss of detailed information during the generation of the fusion image, a skip-connection may be applied between the color image encoder 320/thermal image encoder 330 and the fusion image decoder 340. This fusion image decoder 340 can be referred to as a spectrum-shared decoder.

Such a fusion image decoder 340 can generate a fusion image by integrating the CbCr color information of a color image and the Y channel information of a thermal image. In order to generate a fusion image, the fusion image decoder 340 concatenates the multi-dimensional color image spectrum features and the multi-dimensional thermal image spectrum features for each scale on a channel basis, and can sort the spectrum features for each scale in descending order according to the activation level. For this purpose, the pre-trained loss function of the neural network, which includes a color image encoder 320, a thermal image encoder 330, and a fusion image decoder 340, may include, for the color image and the thermal image, respectively, a restoration loss function consisting of mean squared error MSE loss and structural similarity index measure SSIM loss, and a fusion loss function to ensure that the sum of the gradients of the color image and the gradients of the fusion image are identical.

Referring again to FIG. 2, the input unit 130 can receive various types of information necessary for the processor 120 to perform a method for generating the fusion image by the fusion image generation program 111. For example, it can receive a color image and a thermal image and provide them to the pre-processing unit 310.

The output unit 140 can output various processed data, including the fused image generated as the processor 120 performs the method for generating a fused image. For example, the output unit 140 may include a data interface capable of outputting various processed data, including the fused image, to external peripheral devices, a communication module capable of transmitting various processed data through a communication channel, and a playback device capable of reproducing various processed data so that they can be visually or audibly recognized from the outside.

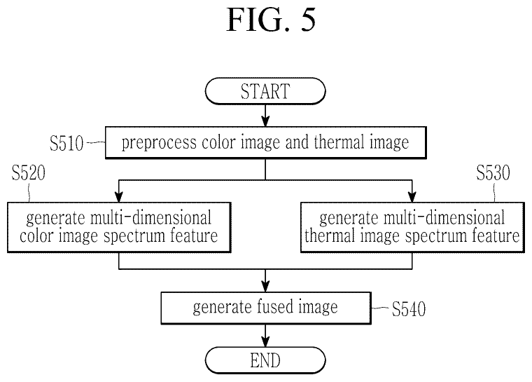

FIG. 5 is a flowchart for explaining method for generating the fusion image performed by the fusion image generation device according to an embodiment of the present invention.

Hereinafter, with reference to FIGS. 1 to 5, a detailed description will be given of the fusion image generation method that can be performed by the fusion image generation device according to an embodiment of the present invention.

First, the processor 120 of the fusion image generation device 100 may load the fusion image generation program 111 and information necessary for executing the fusion image generation program 111 from the memory 110. Then, by executing the instructions included in the fusion image generation program 111, the processor 120 can perform the fusion image generation method according to one embodiment. As a result, the fusion image generation device 100 can be implemented to include a pre-processing unit 310, a color image encoder 320, a thermal image encoder 330, and a fusion image decoder 340. Here, the neural network including the color image encoder 320, the thermal image encoder 330, and the fusion image decoder 340 may be in a pre-trained state so that it can generate a fusion image from a color image and a thermal image.

A color image I_v and a thermal image_1, which are not spatially or temporally aligned, are input through the input unit 130, and the input color image I_v and thermal image I_1 are input to the fusion image generation program 111 executed by the processor 120.

Then, the pre-processing unit 310 of the fusion image generation program 111 performs alignment and pre-processing in a predetermined format for the color image I_v and the thermal image I_1. For example, the pre-processing unit 310 may convert the color image I_v into the YCbCr format and then provide the Y channel as input for the color image encoder 320. In addition, in the step of S510, the pre-processing unit 310 may provide the thermal image as an 8-bit single-channel input for the thermal image encoder 330.

Here, the color image encoder 320 of the fusion image generation program 111 can be pre-trained to generate multi-dimensional color image spectrum features from a pre-processed color image. Accordingly, in the step of S520, the pre-trained color image encoder 320 can generate multi-dimensional color image spectrum features for the color image pre-processed by the pre-processing unit 310.

In addition, the thermal image encoder 330 of the fusion image generation program 111 can be pretrained to generate multi-dimensional thermal image spectrum features from the preprocessed thermal image. Accordingly, in the step of S530, the pretrained thermal image encoder 330 can generate multi-dimensional thermal image spectrum features for the thermal image preprocessed by the preprocessing unit 310.

Furthermore, the fusion image decoder 340 of the fusion image generation program 111 can be pre-trained to generate a fused image, I-fused, by combining multi-dimensional color image spectrum features and multi-dimensional thermal image spectrum features. Accordingly, the pre-trained fusion image decoder 340 can generate a fused image, I-fused, by merging the multi-dimensional color image spectrum features provided by the color image encoder 320 and the multi-dimensional thermal image spectrum features provided by the thermal image encoder 330. In generating the fused image, I-fused, in the step of S540, the fusion image decoder 340 can create the fused image by integrating the CbCr color information of the color image, I_v, and the Y channel information of the thermal image I_1.

Here, the fusion image decoder 340, in order to generate the fusion image, I-fused, concatenates the multi-dimensional color image spectrum features and multi-dimensional thermal image spectrum features for each scale by channel, as shown in Equation 1, and performs the function of a feature line-up module that sorts the spectrum features for each scale in descending order according to their activation level.

$${F}_{fused}^{s} = Sort ( \{ {F}_{v}^{s} ⊕ {F}_{v}^{s} \} ) \qquad [ Equation 1 ]$$

These characteristic line-up module functions enable identification of meaningful information, gradient/meaningful information, that represents scenes at the time of fusion processing for multimodal image generation, without separate learning of such information during fusion.

Meanwhile, the pre-trained loss function of the neural network, which includes the color image encoder (320), the thermal image encoder (330), and the fusion image decoder (340), can be configured as shown in Equation 2.

$$L ( θ , {I}_{v , l} ) = {\sum }_{i} ( {L}_{res} ( θ , {I}_{i} ) ) + α {L}_{fustion} ( θ , {I}_{v , l} ) \qquad [ Equation 2 ]$$

Here, θ is the parameter of the neural network to be learned.

α is a parameter predetermined by the user (developer) during the network training process. The optimal value can be found empirically, and, for example, it can be set to 5.

In Equation 1, as α increases, texture/edge information becomes more pronounced in the fused image; however, as this information becomes stronger, the overall scene information of the image may be distorted.

Equation 2 can be configured as shown in Equations 3 and 4.

$${L}_{res} ( θ , {i}_{i} ) = {L}_{msc} ( {I}_{i} , {I}_{i}^{res} ) + β {L}_{ssim} ( {i}_{i} , {I}_{i}^{res} ) \qquad [ Equation 3 ]$$

Here, β, like α, is a parameter predetermined by the user (developer) during the network training process. The optimal value can be found empirically, and for example, it can be set to 5.

In equation 2, increasing β allows for greater emphasis on structural features in the fused image, but if this information is overly prominent, the intensity information within the image may become distorted.

$${L}_{fusion} ( θ , {I}_{v , l} ) = {‖ {\sum }_{l} ( ∇ ( {I}_{i} ) ) - ∇ ( {I}_{fused} ) ‖}^{2} \qquad [ Equation 4 ]$$

Here, ∇ is a filter operator for extracting gradient information from the image. For example, a Laplacian operator can be applied.

Such equations 2 through 4 may indicate that the pre-trained loss function of the neural network may include a restoration loss function consisting of MSE loss and SSIM loss for the color image (I_v) and the thermal image (I_1), respectively, as well as a fusion loss function to ensure that the sum of the gradients of the color image (I_v) and the gradients of the fused image are identical. This is because, although it is difficult to estimate the actual scene information of the combined image when the color image (I_v) and the thermal image (I_1) are not aligned with each other, at the very least, the gradient information must be able to be combined.

As described above, according to one embodiment, it is possible to generate image fusion that minimizes environmental influences in image information that is greatly affected by external environmental factors such as the direction and intensity of light, so that it can be used in ground unmanned equipment such as autonomous vehicles and various other robotic systems. When a system that utilizes image information is operated by simultaneously mounting a color image camera and a thermal imaging camera, and the generated fused image is used for sensing the target environment, not only can the performance of the system be improved in remote control (driving), control (driving) assistance, and fully autonomous (automatic) control (driving), but safety can also be enhanced.

In addition, the present invention does not require the temporal and spatial alignment of input images (color images, thermal images), which was essential for training the neural network that generates fused images, and allows training to be performed with only a set of color images and a set of thermal images, regardless of whether they are aligned. As a result, it is possible to overcome the difficulty of having to separately obtain or prepare aligned images for training.

Meanwhile, a computer program may be implemented to include instructions for causing a processor to perform each step included in the fusion image generation method according to the above-described embodiment.

In addition, a computer program containing instructions for causing a processor to perform each step included in the fusion image generation method according to the aforementioned embodiment may be recorded on a computer-readable recording medium.

The combinations of each block in the block diagram and each step in the flowchart attached to the present invention may be performed by computer program instructions. These computer program instructions may be loaded onto a general-purpose computer, a special-purpose computer, or other programmable data processing apparatus, such that the instructions executed by the computer or other programmable data processing apparatus create means for performing the functions described in each block of the block diagram or each step of the flowchart. These computer program instructions may also be stored in a computer-usable or computer-readable memory that can direct a computer or other programmable data processing apparatus to function in a particular manner, so that the instructions stored in the computer-usable or computer-readable memory constitute a manufactured article that includes instruction means for performing the functions described in each block of the block diagram or each step of the flowchart. The computer program instructions may also be installed on a computer or other programmable data processing apparatus, such that a series of operational steps are performed on the computer or other programmable data processing apparatus to produce a computer-implemented process, so that the instructions executed on the computer or other programmable data processing apparatus provide steps for executing the functions described in each block of the block diagram and each step of the flowchart.

In addition, each block or each step may represent a module, segment, or portion of code containing one or more executable instructions for implementing specified logical functions. Also, it should be noted that, in some alternative embodiments, the functions mentioned in the blocks or steps may occur out of order. For example, two blocks or steps that are illustrated in succession may, in fact, be executed concurrently, or the blocks or steps may sometimes be performed in reverse order, depending upon the functionality involved.

The above description is merely an exemplary explanation of the technical concept of the present invention, and those of ordinary skill in the art to which the present invention pertains will be able to make various modifications and alterations without departing from the essential quality of the present invention. Accordingly, the embodiments disclosed in the present invention are intended to describe, not to limit, the technical concept of the present invention, and the scope of the technical concept of the present invention is not limited by these embodiments. The scope of protection of the present invention should be interpreted according to the claims below, and all technical concepts within an equivalent scope should be construed as being included in the scope of rights of the present invention.

1. A method for generating a fusion image using a fusion image generation device, comprising:
performing temporal and spatial synchronization on a color image and a thermal image, and preprocessing them into a predetermined format;
generating multi-dimensional color image spectrum features from the preprocessed color image using an encoder for color images in a pre-trained neural network;
generating multi-dimensional thermal image spectrum features from the preprocessed thermal image using an encoder for thermal images in the pre-trained neural network; and
performing a function of a feature line-up module by fusing the multi-dimensional color image spectrum features and the multi-dimensional thermal image spectrum features using a decoder for fusion images in the pre-trained neural network to generate a fusion image and by concatenating the multi-dimensional color image spectrum features and the multi-dimensional thermal image spectrum features for each scale at the channel level, and sorting the spectrum features for each scale in descending order according to activation level.

2. The method of claim 1, wherein the preprocessing comprises converting the color image into data in YCbCr format, extracting the Y channel data from the converted YCbCr format data to provide as input to the encoder for color images, and providing the thermal image composed of single-channel data as input to the encoder for thermal images, and
wherein the generating the fusion image comprises combining a CbCr channel data from the YCbCr format data of the color image and a single-channel data of the thermal image as the Y channel data to generate the fusion image.

3. (canceled)

4. The method of claim 1, wherein the pre-trained loss function of the neural network comprises a restoration loss function consisting of an MSE (mean squared error) loss and an SSIM (structural similarity index measure) loss for the color image and the thermal image, respectively, and a fusion loss function configured such that the sum of the gradients of the color image and the gradient of the fusion image can be identical.

5. A device for generating fusion images, the device comprising:
a memory storing instructions; and
a processor executing the instructions; and
wherein the processor, by executing the instructions, performs temporal and spatial synchronization on a color image and a thermal image, preprocesses them into a predetermined format, generates multi-dimensional color image spectrum features from the preprocessed color image using an encoder for color images in a pre-trained neural network, generates multi-dimensional thermal image spectrum features from the preprocessed thermal image using an encoder for thermal images in the pre-trained neural network, and fuses the multi-dimensional color image spectrum features and the multi-dimensional thermal image spectrum features using a decoder for fusion images in the pre-trained neural network to generate a fusion image and after concatenates the multi-dimensional color image spectrum features and the multi-dimensional thermal image spectrum features for each scale at the channel level, and sorts the multi-dimensional color image spectrum features and the multi-dimensional thermal image spectrum features for each scale in descending order according to activation level, thereby performing a function of a feature line-up module.

6. The device of claim 5, wherein the processor, during the preprocessing, converts the color image into data in YCbCr format, extracts the Y channel data from the converted YCbCr format data to provide as input to the encoder for color images, provides the thermal image composed of single-channel data as input to the encoder for thermal images, and
wherein, during the fusion image generation, combines the CbCr channel data from the YCbCr format data of the color image and the single-channel data of the thermal image as the Y channel data to generate the fusion image.

7. (canceled)

8. The device of claim 5, wherein the pre-trained loss function of the neural network comprises:
a restoration loss function consisting of an MSE loss and an SSIM loss for the color image and the thermal image, respectively; and
a fusion loss function configured such that the sum of the gradients of the color image and the gradient of the fusion image can be identical.

9. A computer-readable recording medium storing a computer program, wherein when executed by a processor, the computer program causes the processor to perform a method for generating a fusion image according to claim 1.

10. A computer program stored in a computer-readable recording medium, wherein when executed by a processor, the computer program causes the processor to perform a method for generating a fusion image according to claim 1.

11-12. (canceled)
